(19) United States
(12) Patent Application Publication
(10) Pub. No.: US 2005/0140941 A1
(43) Pub. Date: Jun. 30, 2005

(54) Portable visual display

(76) Inventor: Alan Maddock, Buckiinghamshire (GB)

Correspondence Address: TESTA, HURWITZ & THIBEAULT, LLP, HIGH STREET TOWER, 125 HIGH STREET, BOSTON, MA, 02110, US

(21) Appl. No.: 10/504,653

(22) PCT Filed: Feb. 17, 2003
(86) PCT No.: PCT/GB03/00681

(30) Foreign Application Priority Data
Feb. 16, 2002 (GB) 0203722.4

(51) Int. Cl. G03B 21/22

(52) U.S. Cl. 353/119

(57) ABSTRACT

An adaptor 18-21 provides users of portable visual display such as projection systems (7-1) with convenient means to select, attach, transport and use a variety of presentation or visual display accessories. In one embodiment, the invention has the appearance of an attache case and contains all the accessories required in a ready-to-use package. The adaptor may include a media source such as a laptop computer, videoconferencing unit or a DVD player, and permit a user to interchange these in a modular manner and be operational in seconds.

The field of this invention is that of portable visual display devices, and in particular relates to a system for accessory attachment for portable projection apparatus.

Presentation and Visual Display is becoming a major market worldwide. In the case of portable displays, projection by small projectors has become commonplace. This involves projecting the image onto a remote frontal projection screen that is normally white or coated with reflective material.

Presentations and visual display techniques in their various forms (i.e. for Business, Education, Training, Videoconferencing, Remote Medicine) rely largely on the technology of portable projectors. These very small machines can produce a high resolution, high quality image when projected onto a remote front projection screen. The signal or data for the projected image is analogue or digital and is normally generated by a media source that can be a “laptop” computer, a videoconferencing system, a DVD player or any other portable image/video source.

Despite the advancing technology of projectors, the projection process itself still involves much user effort to make a mobile presentation or display. Users of portable projection normally experience several problems when making presentations or visual displays, often relating to the room environment, the setting up of the equipment and the conducting of the presentation. It is still a serious inconvenience to many users to set up, interconnect, adjust and align all of the equipment. Many users are reluctant to use projection due to the inconvenience as well as the requirement of time and some basic knowledge of the equipment concerned. The following explains some of the problems to be resolved.

Environment

The lighting can be a problem when projecting onto a white screen in everyday situations open to sunlight. Using a projector in a small room is often difficult due to the distance required from screen to projector. Requiring a screen or white wall available is a major constraint, as the user relies on the room having a screen already installed, or this inconvenient and bulky apparatus must be carried.

Set Up

The projector has to be unpacked from its protective case or bag, its lens cap removed and positioned. Similarly the power cable is unpacked and attached to the projector and is often too short to reach a wall socket.

The media unit provides the signal or data source (typically a computer) has to be independently carried in another case or bag, unpacked and usually requires to be plugged in via its power cable to another wall socket, the media prepared and the signal cable unpacked and connected.

A portable screen requires space to be available and the screen to be set-up and aligned. Unless in a special presentation room, the projector has to be positioned with a clear unobstructed light path to the screen, then adjusted for zoom and for image horizontal and vertical position, focus and finally keystone correction (to avoid the image on the screen appearing as non-rectangular).

Even in large rooms the projector usually sits in the middle of the participants' table, with cables running onto the table and off to the media. A projector remote control and pointing device are usually carried, although there is no specific place for such items. The presenter also has to carry or prepare other equipment such as a radio mouse, intranet connections, microphone or sound system is required.

At the end of the presentation, the entire apparatus described above has to be re-packed.

User Convenience

The above represent a significant number of inconveniences to users of current portable projection, as the current apparatus is not “plug & play”, requires some knowledge and takes several minutes to prepare. Even when the equipment is available, many potential users will not attempt to use projectors for these varied reasons.

A number of attempts have been to improve on the conventional systems. For example, some prior art exists in the form of projection apparatus enclosed and used within a case, with additional components useful for projection.

U.S. Pat. No. 5,218,389 (Harlon, et al.) discloses a portable interactive multimedia presentation unit. This invention refers to a case capable of carrying projection apparatus and computer equipment.

GB 892 809 (Voigtlander Aktiengesellschaft) discloses a case for an Optical Projector.

WO99/46932 (Alan Maddock) relates to a portable visual display device with a collapsible presentation screen.

Each of the above uses a case enclosing a projection apparatus and another specified piece of equipment or apparatus (i.e. a computer screen, movable divider walls and a folding viewing screen respectively) with the intent of addressing a specific objective as a portable visual display device.

The invention of WO99/46932 (inventor is present applicant) partially addresses the same problem and discusses the option of carrying projection accessories within the case of the folding screen, the case also contains a projection apparatus. This optional solution proposed within this invention only addresses some of the problems and still has inherent problems of a bulky case, lack of user convenience (carrying of accessories), and lack of ability to be configured (only small “plug-in” modules are practical).

The solutions of the prior art do not propose to the user any flexible method of configuring the projection apparatus according to his needs. It is desirable to include the ability to carry the cables in an accessible pre-connected manner, with the option of attaching and carrying additional accessories in an interchangeable manner. Such accessories include media “modules”, which carry the image/video source or other optional accessories for a presentation or visual display. As a laptop computer is the commonest form of media then a solution to carrying and easily using such a large item is required.

It would therefore be desirable to provide a portable display adaptor that obviates, or at least mitigates one or more of the drawbacks associated with the prior art.

It is one object of the invention to provide means for reducing or eliminating the typical and varied inconveniences of portable projection.

It is a further object of the invention to provide an autonomous solution that is configurable by a user in order to meet his requirements and to avoid the inconveniences in the vast majority of typical uses (business, professional, promotional, marketing, advertising, communication, training or educational).

According to a first aspect of the invention there is provided an adaptor for a visual display apparatus having a projection apparatus, said adaptor comprising:
attachment means for attaching said adaptor to the visual display apparatus, the attachment means being provided on the exterior of the adaptor;
accessory storage means for the carrying and/or attaching of accessories as required for visual display, projection or presentation purposes;
signal connection means for the connection of a data, video, or other image signal to the visual display apparatus.

The signal connection means may be electrical contacts.

Alternatively, the signal connection means may be a wireless connection.

In one embodiment, the adaptor is arranged such that it allows the signal connection means to remain connected during the transport of the visual display apparatus.

The accessory storage means may be detachable from the adaptor.

The adaptor assembly may further comprise an attachment means between the adaptor and an accessory or accessory storage means, thus permitting a user to equip or configure the adaptor assembly with said accessory or accessory storage means.

The adaptor may comprise a receptacle to receive the storage assembly.

Th storage assembly is preferably at least partially removable from the receptacle.

The accessory storage means may comprises one or more of the following: a frame around which cables may be stored, an enclosure with an aperture, an enclosure with a door or lid element, an enclosure with compartments.

The accessory storage means may store power and/or signal cables, audio-visual media or other image signal sources, communication devices, sound systems, power supplies, remote control devices, computer accessories, or pointing devices.

The accessory storage assembly preferably comprises means for signal and/or electrical interconnection, for the connection of an accessory or an accessory storage assembly.

Optionally, the adaptor and the accessory storage means each comprise cooperating contact means permitting signal or power interconnection.

The accessory storage means may be a drawer assembly.

The accessory storage means may be a removable module.

The accessory storage means may contain a sub-storage assembly attached to the said accessory storage means.

The accessory storage means and the sub-storage assembly may each comprise cooperating contact means permitting signal or power interconnection.

The adaptor may allow the simultaneous attachment of a plurality of accessory storage means in a stackable manner.

Optionally, the accessory storage means contains a collapsible projection-viewing screen.

The adaptor may further comprise a handle or carrying strap.

The adaptor may comprise means for inclining the projection apparatus.

In one embodiment, the adaptor comprises an upper assembly with the projection apparatus attached thereto, and a lower base section, the upper assembly and the lower base section connected by joining means, the joining means permitting the lifting and/or inclination of the projection apparatus relative to the lower base section.

The adaptor provides attachment to a projector apparatus and provides a common support for the attachment of accessories that may be required for projection/presentation/visual display.

The adaptor provides a means for the user to configure the equipment in a ready to use manner to permit quick and easy presentation/visual display. This may include a common attachment means and various accessory storage units of common format enabling a user to attach optional and interchangeable accessories.

Such accessories and storage units may contain media that will operate as an image or video signal for the projection apparatus.

Such accessories and storage units may include media that is larger than the projection apparatus (i.e. a laptop computer).

Such media attachment means may include the power and signal connections as required to provide the image to the projection apparatus in a convenient or automatic manner.

It is a desirable object of the present invention that the adaptor assembly may provide addition protection to the projection apparatus such as to replace the habitual protective carry bag or transport case.

The accessories may include a means to carry a screen unit (removing the user's dependency on having a screen available or carrying one).

Various embodiments of the invention may provide the following features and advantages.

The adaptor for a projection apparatus features mechanical and electrical attachment means. A user can configure the adaptor according to his requirements by the attachment of various accessories.

An embodiment of the invention features the ability to operate and make a presentation/visual display without opening and unpacking any projector or equipment of any sort from any carry-case or bag. This can be achieved without making any connections to the projection apparatus, without connecting signal or power connections to a media source, and without connecting any separate sound system. Thus the system is set up without any significant user effort, being operational in seconds and will also provide multiple desirable features to a user that are not otherwise available.

The projection apparatus can operate while attached to the adaptor assembly or enclosed by it and that any connections to the projection apparatus for operation may remain so connected during transport.

Accordingly, an adaptor assembly for a portable visual display device comprises an attachment means for an optical projection apparatus that produces visual images on a viewer screen.

The adaptor assembly may be constructed such that the projection apparatus cables may remain connected at all times. These may include the power cable and the signal cables. Such cables may be stored ready to be extracted for external connection to a power supply or media source.

The adaptor permits the user attachment of accessories or accessory storage units and preferably in a common and interchangeable format. The accessories may be of varying types and including varying media sources to provide the image signal.

The adaptor and accessory storage units may comprise the means to permit the signal and power connections to be made automatically when the accessory storage unit is attached in place.

A particular embodiment of the invention permits the projection assembly to be inclined relative to a base and that by the further attachment of a mirror then the distance to the screen is decreased and the light path raised avoiding table obstacles and keystone effects.

The adaptor may comprise a fold-out screen assembly in an integral manner or is attached in a modular manner. This screen may operate as a rear projection unit similar to a very large screen monitor/television unit.

In compliance with the said objectives, any existing case of the projection apparatus may serve partially or wholly as the adaptor assembly thus permitting the direct attachment of accessories or accessory storage units.

The said adaptor assembly may include a carry handle for easy portability and may be designed to provide additional protection to the projection apparatus while being carried from place to place.

A possible embodiment of the invention is as an optional accessory to commercial projectors.

Other alternative features of the invention will become apparent from reading the following description.

There will now be described, by way of example only, various embodiments of the invention with reference to the following drawings, of which:

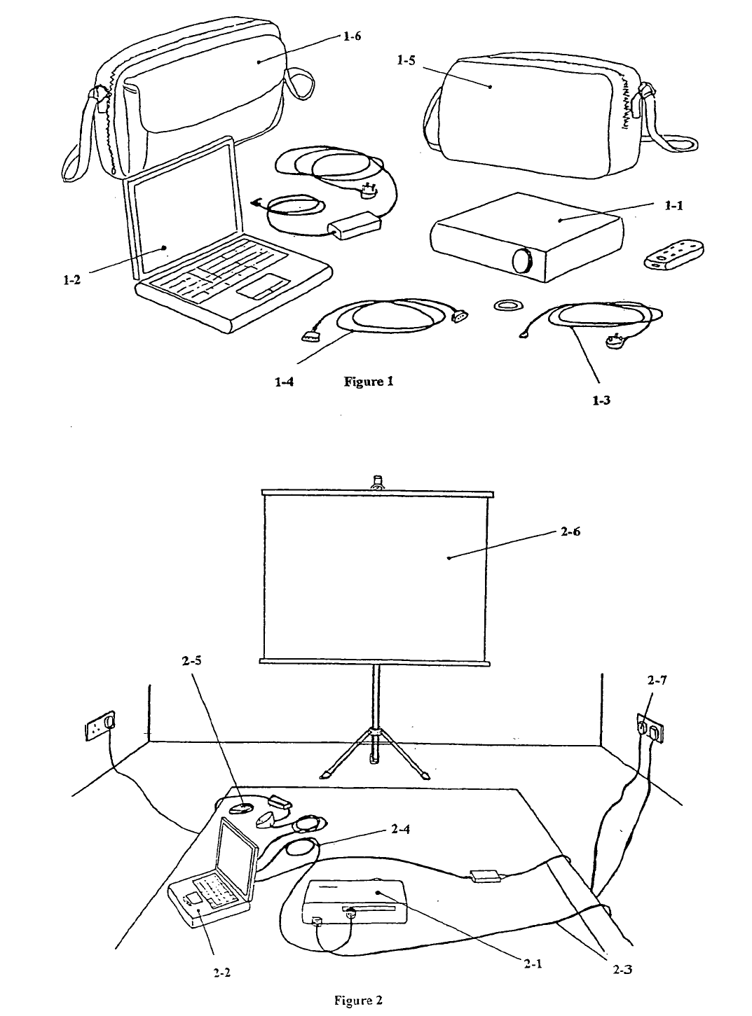

FIG. 1 is a perspective view that shows the typical equipment required to be carried and prepared before performing a presentation using conventional portable projection equipment.

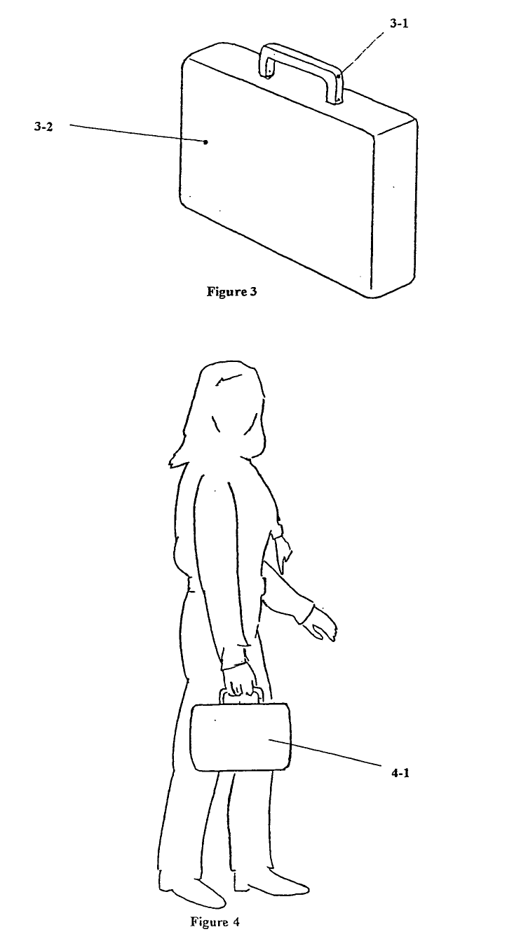

FIG. 2 is a perspective view that shows the conventional equipment prepared and ready to perform a presentation in a typical room.

FIG. 3 is a perspective view that shows the projection equipment contained within a more desirable presentation as a handy “attache” case.

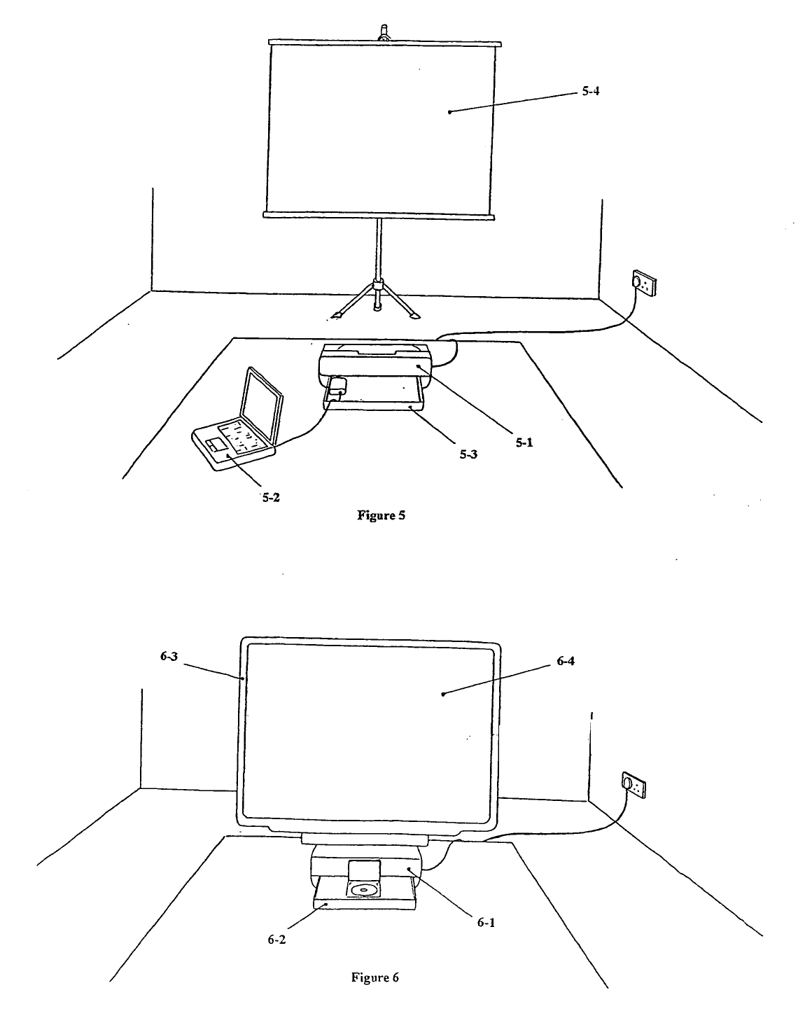

FIG. 4 is a perspective view that shows how a possible solution in the form of an attache case is readily carried from place to place for presentations and visual display.

FIG. 5 is a perspective view that shows an example of how such a preferable solution could operate during a presentation.

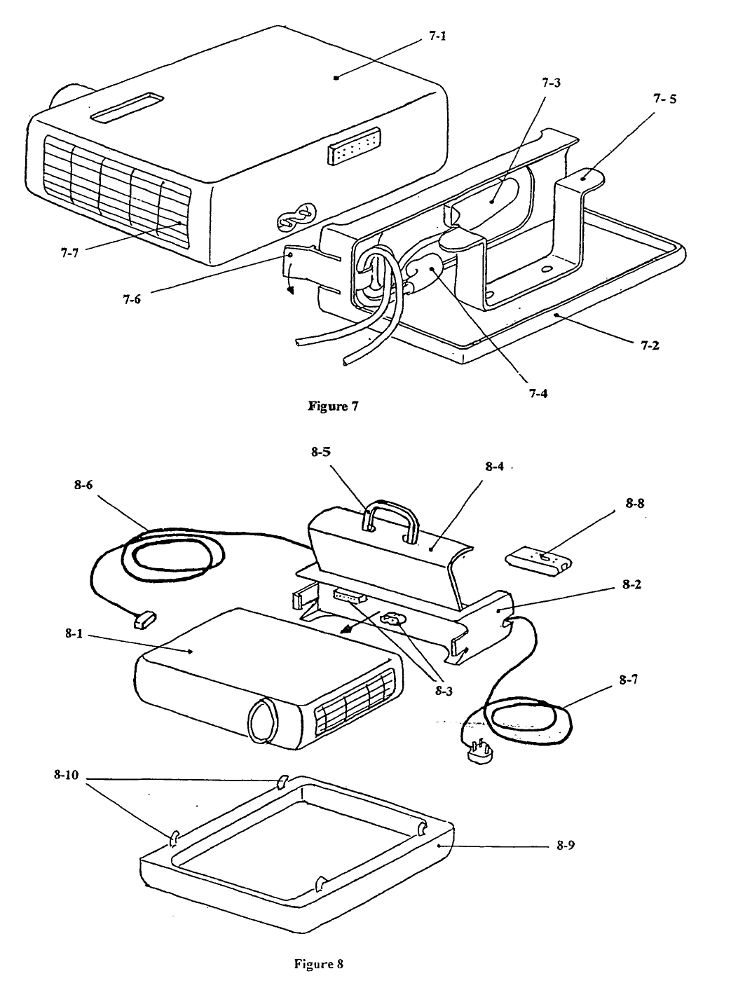

FIG. 6 is a perspective view that shows a further example of a preferable solution whereby a fold out screen can be deployed to give a visual display similar to a large monitor.

FIG. 7 is a perspective view that shows by example a simple embodiment of the invention as an adaptor assembly in the form of a frame plus cables with attachment points permitting the attachment of the projection apparatus.

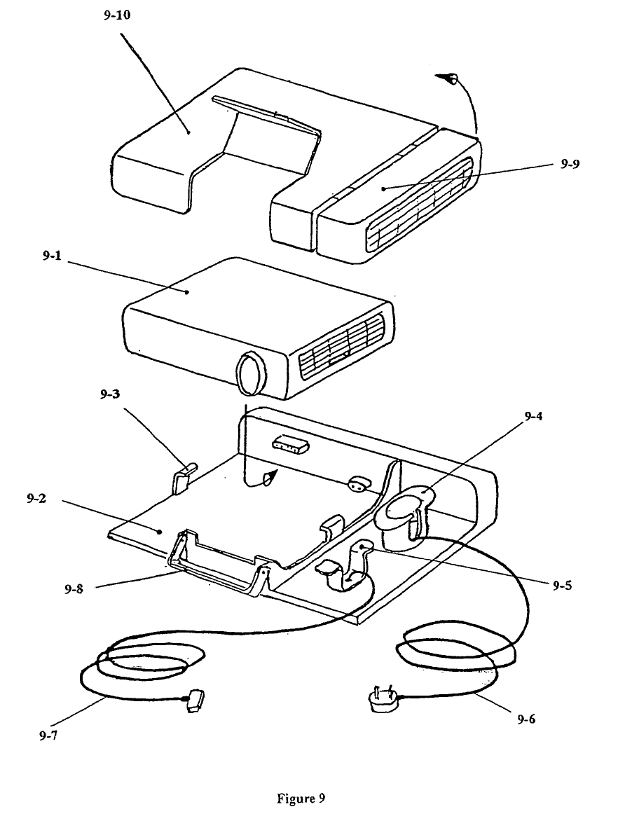

FIG. 8 is a perspective view similar to the previous figure in which the frame of the adaptor assembly is extended to act as an openable enclosure for accessories—in this case the power cable and the signal cable. A further accessory storage tray is shown below that attaches partially to the adaptor frame and partially to the projector.

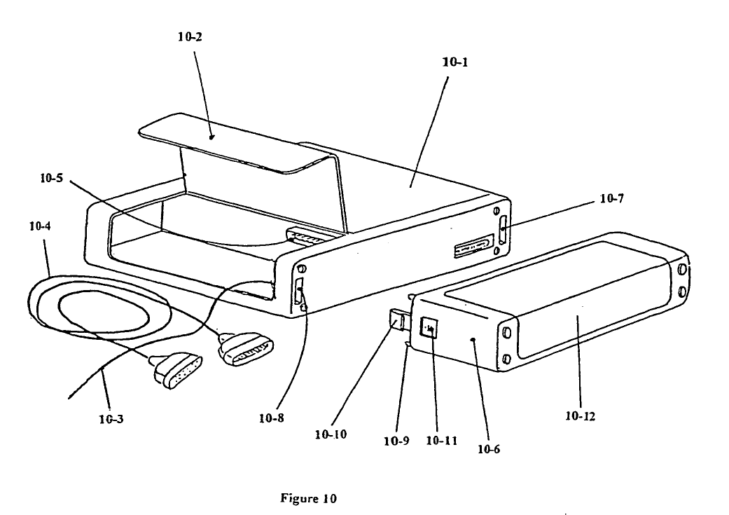

FIG. 9 is a perspective view that shows a visual display device consisting of a case that encloses a projection apparatus, that may contain accessories. This figure is not considered as an embodiment of the invention, but is included for clarity.

FIG. 10 is a perspective showing a visual display device as shown in FIG. 9, and a further adaptor assembly similar to that of FIG. 8 that may carry other accessories such as a media source.

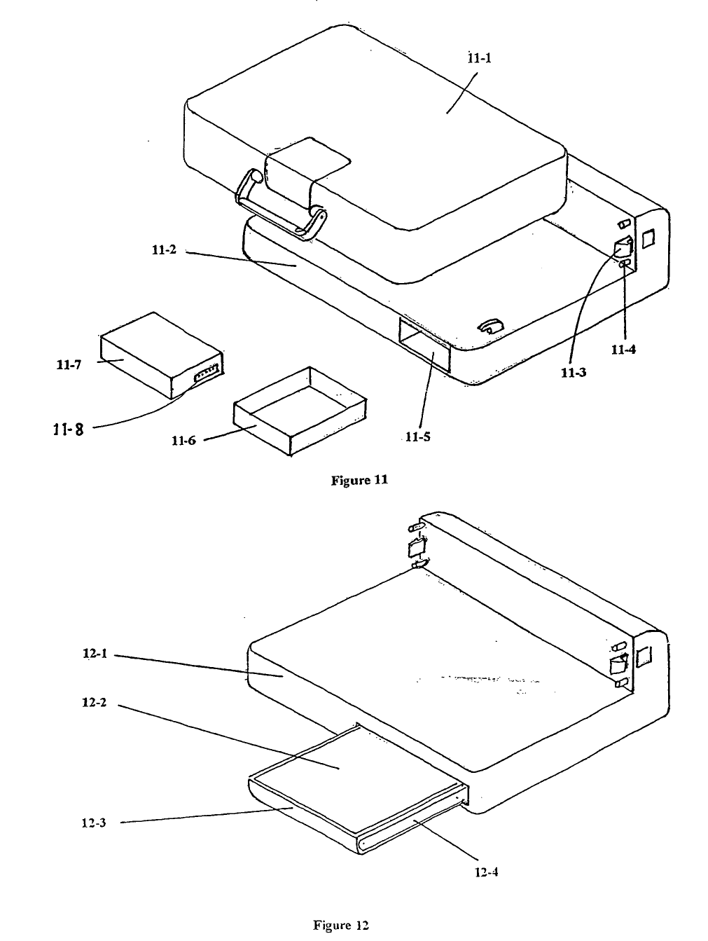

FIG. 11 is a perspective view that shows an adaptor as in FIG. 8 and in the form of an “L” shape. The adaptor can contain one or more internal receptacles that can receive modules that may each consist of or contain differing accessories or media devices.

FIG. 12 is a perspective view that shows an adaptor (12-1) as described in FIG. 11. The adaptor could contain accessories or media sources (12-2) within partially or wholly removable drawers (12-3) mounted on slide mechanisms (12-4), the accessories, media and/or the drawers themselves being interchangeable.

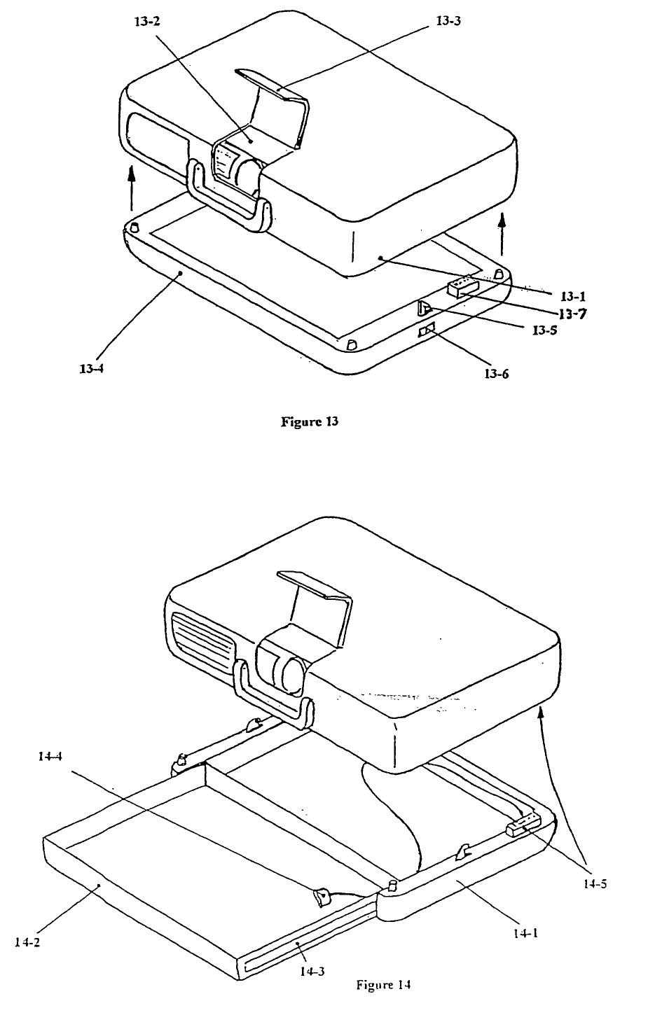

FIG. 13 is a perspective view showing a visual display device with the adaptor in the form of a large accessory storage assembly that attaches below.

FIG. 14 is a perspective view showing how an accessory storage unit can include a further drawer-like element that can be easily extracted by the user to access its contents.

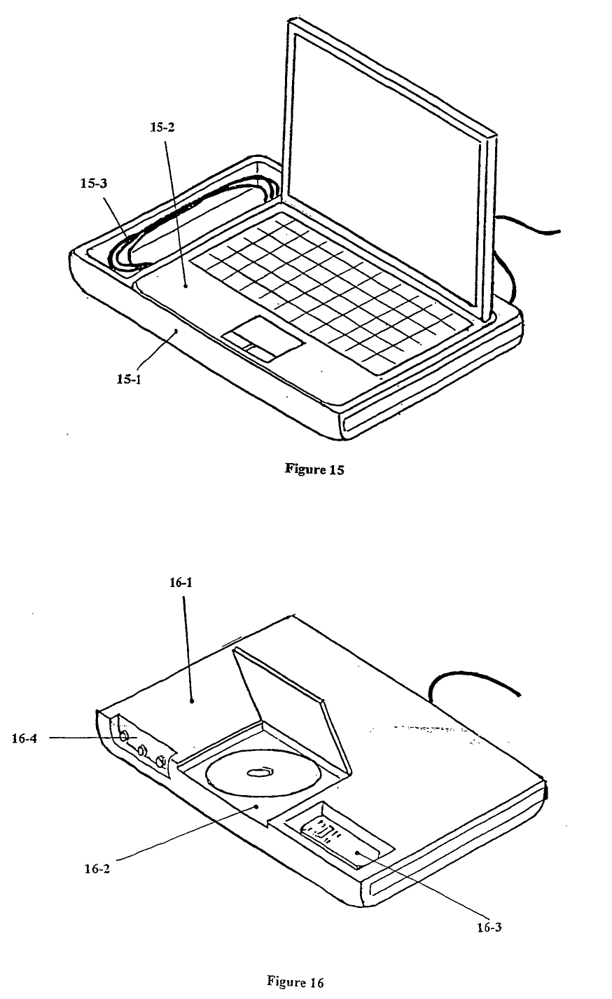

FIG. 15 is a similar perspective view similar to the previous figure showing only the drawer element and how it could contain a laptop computer with cabling connected.

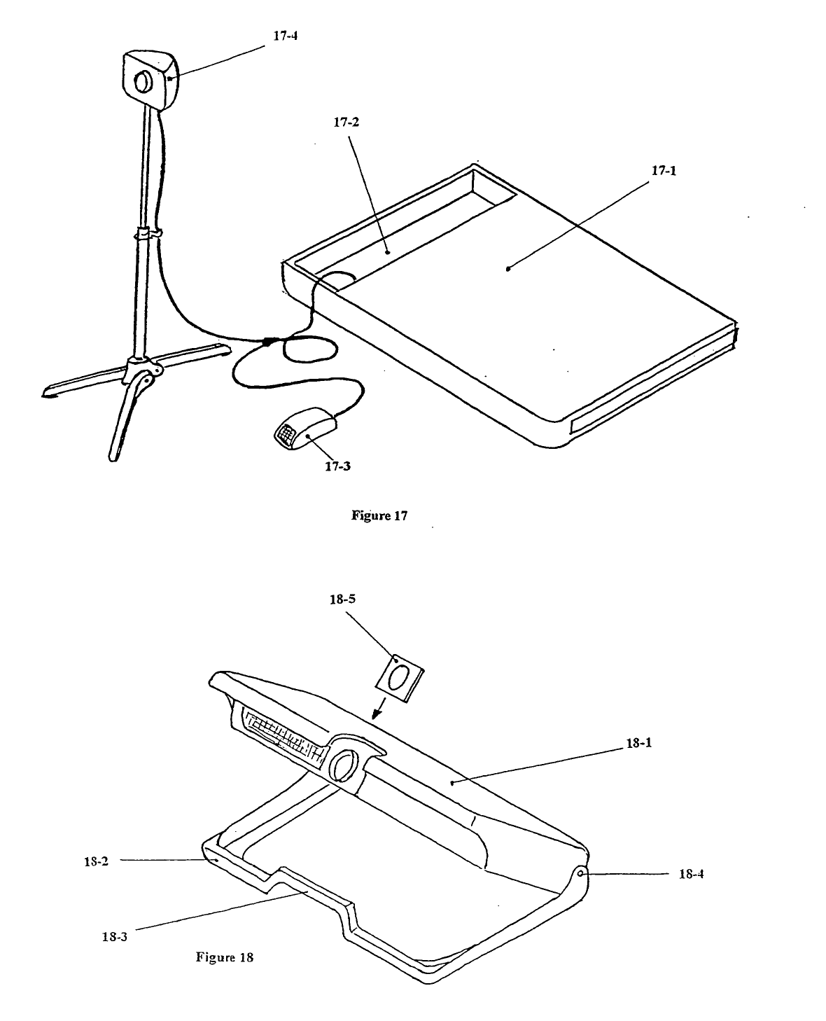

FIG. 16 is a perspective view similar to the previous figure that shows another drawer element containing a DVD player and sound system.

FIG. 17 is a perspective view similar to the previous figure that shows another drawer element containing a videoconferencing system.

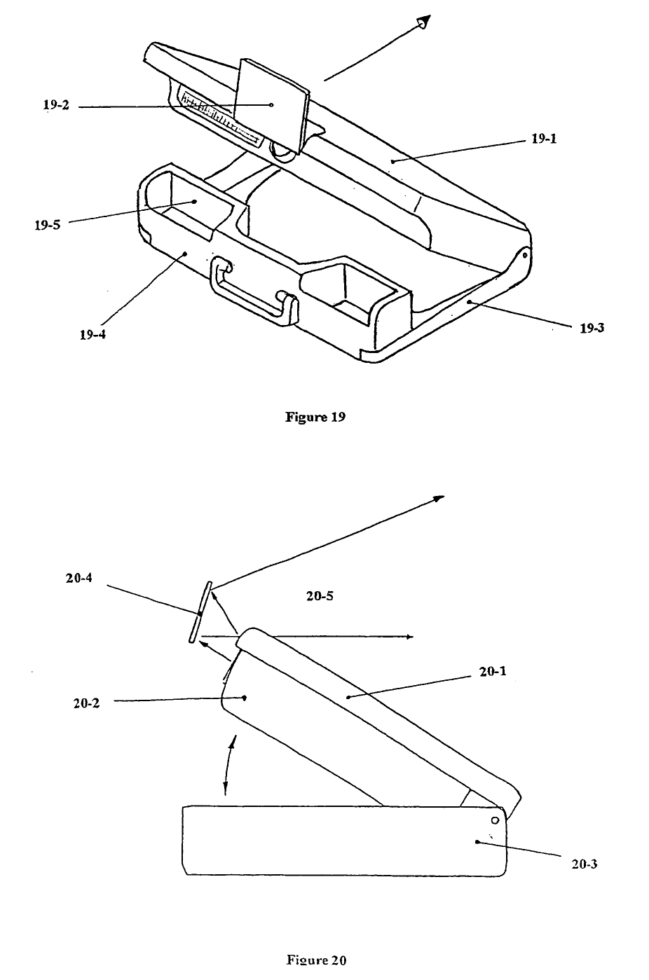

FIG. 18 is a perspective view that shows an alternative configuration whereby the adaptor assembly comprises a base with carry handle and permitting the projection apparatus to be inclined.

FIG. 19 is a perspective view that shows a similar configuration and in which the adaptor assembly comprises a module that may be attached to the base of the adaptor assembly and a mirror utilised to reflect the image optical path over the top of the unit.

FIG. 20 is a side view that shows a similar configuration with the mirror attached.

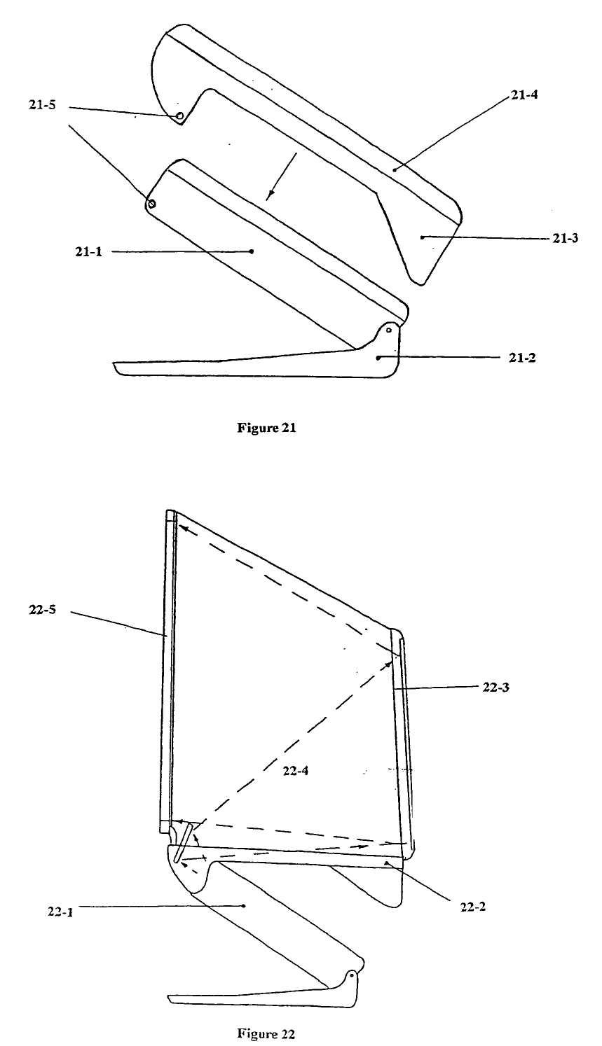

FIG. 21 is a side view that shows a similar configuration and where a module is attached containing a foldout screen unit.

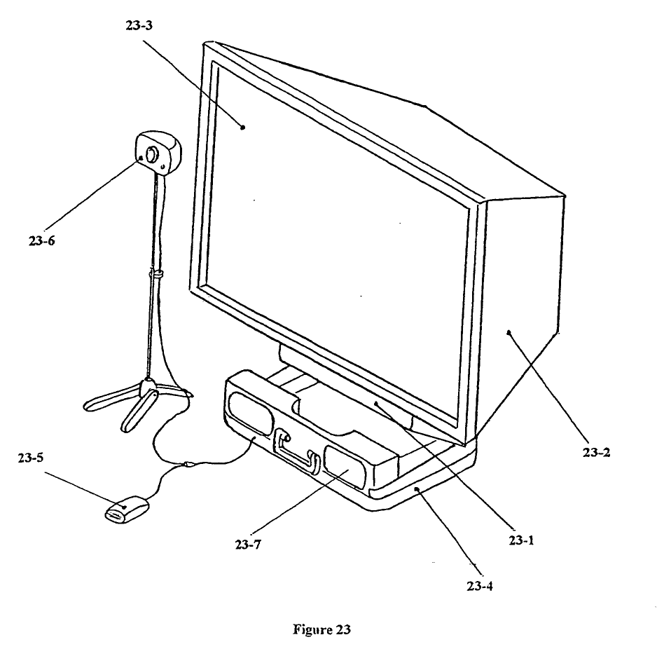

FIG. 22 is a side view that shows a similar configuration and whereby the foldout screen module is deployed to operate as a rear projection screen.

FIG. 23 is a perspective view that shows a similar configuration operating as a rear projection screen and also with a videoconferencing module attached below the base.

Within the objective of reducing or eliminating the inconveniences to a projection user, the present invention is based on providing an adaptor means permitting a projection apparatus to have attached the various accessories as may be required for projection, presentations or visual display. The adaptor means may also serve for other purposes such as for the protection to the projection apparatus (thus eliminating additional carry cases).

Within the context of this application, accessories are defined as any peripheral or associated items or equipment that may be separate from the projection apparatus and that are essential or optionally required in order to operate or control the display or presentation. The accessories may be data or signal sources or storage, or provide additional features. Such accessories may include, among others, such items as cables, signal sources & media, remote controls or pointing devices, lens adaptors, communication devices, microphones, and sound systems and may include the carrying means for any of the aforementioned items.

FIGS. 1 and 2 are general drawings not specifically relating to the invention, but representing an overview of conventional apparatus and a typical operating environment within which portable presentation and visual display may be made. FIGS. 3 through 6 are general drawings presented only by way of example and show various means in which to carry or transport the equipment, and perform the presentation or display. These are by way of reader information and should not necessarily be considered as embodiments of the present invention.

FIG. 1 is a general perspective view that shows the typical equipment that must be carried and set up in order to perform a presentation or visual display using a portable projector. In this case the media (image signal source) is a laptop computer. The projection apparatus (1-1), a laptop computer (1-2), a power cable (1-3) and a signal cable (1-4) are the basic items for a presentation. The carry bag (1-5) is required to transport the projection apparatus and other accessories. The carry bag (1-6) is used to carry the computer with its accessories such as its power adaptor. Many other accessories (not necessarily shown) such as remote controller, lens protector cap, a pointing device or a remotely operated computer mouse may also be carried.

FIG. 2 is a general perspective view that shows the typical set up when performing a presentation using portable projection equipment within a large room. A portable projector (2-1) is sitting in the centre of a table with a laptop computer (2-2) providing the image signal through a cable (2-4). A remote pointing device (2-5) and a portable screen (2-6) are also shown with the power cables (2-3) connected to a remote wall socket (2-7). The equipment preparation takes several minutes, and the final set-up looks messy and unprofessional. Adjusting the image height, zoom, focus and keystone also takes time. All obstacles in front of the projector and within the projected light path must be removed and power cables can be tripped over.

FIG. 3 is a general perspective view showing a preferable solution illustrated as an assembly with a presentation similar to a carry case for the projection equipment and accessories. The overall appearance could be a shoulder bag or a carry case (3-1) as would be used while being carried from place to place by say a travelling salesperson, a school teacher, a training instructor or a group wishing to do videoconferencing.

FIG. 4 is a general perspective view showing an assembly similar to that of FIG. 3 and showing the relative size of the assembly and means by which it may be carried. In this example as a small hand carried executive attache case.

FIG. 5 is a perspective view showing a case (5-1) similar to that of FIG. 3 and used within the context of the situation shown in FIG. 2 with a computer (5-2) that remains connected and ready to operate. In this illustration of a preferable solution, a drawer element (5-3) is attached to the carry case and acts as a storage assembly for the computer so that it can be removed from the drawer element for use and returned to the drawer element for carrying from place to place. As the computer remains connected then the start up of the presentation or display is almost immediate.

FIG. 6 is perspective view showing an assembly similar to that of FIG. 5 and used within the context of the situation shown in FIG. 2. The case (6-1) comprises a drawer element (6-2) that contains an alternative media in the form of a DVD player. It also includes a screen accessory (6-3) that can be attached thereby permitting the combined assembly to operate in a manner identical to a large monitor display screen (6-4) and thus not requiring the remote and bulky projector screen. A further advantage is that such a screen if used in rear projection can be used in more typical lighting conditions such as in normal rooms.

The following figures are intended to illustrate the various elements, assemblies and embodiments of the invention.

FIG. 7 is a perspective view that shows an embodiment whereby a visual display consisting of a projection apparatus (7-1) may be attached to an adaptor assembly (7-2). The adaptor assembly may be a simple frame element and may comprises the signal connection (7-3) and power connection (7-4) that are required to be attached to the projection apparatus for operation. The frame element may act as storage for cables by providing a cable storage frame element (7-5) around which they may be rolled for transport. The adaptor assembly can be attached to the projection apparatus by simple clips (7-6) that latch into recesses or ventilation grilles (7-7) and that can be readily user opened by pulling in the direction of the arrow indicated.

FIG. 8 is a perspective view similar to the embodiment of FIG. 7, but from a different perspective. The signal connection means between the projection apparatus (8-1) and the adaptor assembly (8-2) is shown here as a set of cooperating contacts comprising fixed and matching connectors (8-3). The arrangement is such that the connection to the projection apparatus is made automatically when the adaptor is attached to the projection apparatus. The embodiment also comprises an extension to the frame element of the adaptor assembly (8-2) to form sides and permit attachment of a lid element (8-4) such as to present an enclosure that may be opened by a user. The adaptor assembly or lid element may have a handle element (8-5) and the enclosure used as storage for the signal cable (8-6) and power cable (8-7) or other accessories such as a remote control (8-8). The figure also shows a simple accessory storage element (8-9) in the form of a large receptacle for miscellaneous accessories that may attach from below by a clip means (8-10) to the projection apparatus and the adaptor assembly. It should be noted that the case of the projection apparatus in this case then acts partially (or wholly) as an attachment means for accessory storage elements. In addition, the connectors may be of differing forms such as optical or radio transceivers.

FIG. 9 is an exploded perspective view that illustrates a visual display device consisting of a case that encloses a projection apparatus, that may contain accessories. This figure is not considered as an embodiment of the invention, but is included for clarity.

The projection apparatus (9-1) attaches to an adaptor assembly (9-2) by means of the clips (9-3). Separate cable storage frame elements (9-4 & 9-5) enable the power and signal cables (9-6 & 9-7) to be rolled up and the assembly carried by means of a handle (9-8). The adaptor assembly may include means to carry the cables and other accessories within an enclosure formed by a lid element (9-9) that opens in the direction of the arrow shown. The adaptor assembly may comprise means to protect and support the projection apparatus during transport by means of a cover element (9-10). This may be attached by any appropriate means and may comprise apertures for ventilation and may comprise an aperture and door for the exit of the projected image (9-11).

FIG. 10 is a perspective view wherein some of the features of FIGS. 8 and 9 are combined. The adaptor assembly (10-1) comprises a cover element and an enclosure that acts as an accessory storage with a lid (10-2). The power cable (10-3) and the signal cable (10-4) may be transported within the aforesaid enclosure and the enclosure comprises a connector means (10-5) permitting the signal cable to be attached or detached as required.

FIG. 10 also shows an alternative accessory storage assembly similar to that of the adaptor assembly of FIG. 8. Here the accessory storage assembly (10-6) attaches to the adaptor assembly (10-1) via clip emplacements (10-7 & 10-8) and location guide elements (10-9) and clips (10-10—only one visible). The clips can be user-released by pressing the clips through the window (10-11). Accessories can be stored in an integral or removable manner via the lid (10-12) within the enclosure that may act substantially as a general accessory storage compartment and may also contain media such as, a PC-Card Reader or small sound system.

FIG. 11 is a perspective view from the front illustrating a further embodiment of the invention wherein basic accessories or media devices can be more conveniently stored. The visual display device (11-1) and adaptor (11-2) is as in FIG. 8 and in the form of an “L” shape and has similar attachment means (11-3) and guides (11-4) to that of FIG. 10. The visual display device and the adaptor may communicate signals via matching and mating plugs or cooperating electrical contacts. However, they may alernatively communicate by optical or radio signals.

The adaptor can contain one or more receptacles (11-5) that can receive storage modules (11-6) that may each contain differing accessories or media devices. The modules and receptacles may have matching and mating plugs or cooperating contacts permitting signal and/or power connection as shown on module (11-7) by the plug element (11-8.

FIG. 12 is a front perspective view that shows an adaptor as shown in FIG. 11. The adaptor (12-1) could contain accessories or media sources (12-2) within partially or wholly removable drawers (12-3), the accessories, media and/or possibly the drawers having slide mechanisms (12-4) and being themselves being interchangeable.

FIG. 13 is a front perspective view of a further embodiment of the invention wherein the visual display device (13-1) attaches in a vertical manner to an adaptor assembly (13-2) situated below the visual display device via sliding clips (13-3) and release buttons (13-4), or other appropriate means that engage into receiving means on the underside of the adaptor assembly. The accessory storage may be a simple tray or receptacle for accessories or media sources or electrical connection can made via the connector block (13-5). It should also be noted that lower attaching adaptors could be stacked to provide multiple accessory and/or media storage (not shown).

It will be appreciated that it may be desirable to carry larger media. Accordingly a further solution is proposed.

FIG. 14 is a partially exploded perspective view of an embodiment of the invention. The accessory storage assembly (14-1) now further comprises a sub-storage method in the form of a partially or wholly extractable drawer assembly (14-2) and its guides or sliding mechanisms (14-3) that engage within similar receiving elements of the accessory storage assembly. Also illustrated is a cable and plug for the attachment of signal from a media source (not shown). To permit ease of connection of power or signal between the accessory storage assembly and the adaptor assembly, then a matching plug or similar contact assembly (14-5) may be comprised as part of the accessory storage assembly (and adaptor assembly not visible in the view but indicated by the arrow).

FIG. 15 is a perspective view of the drawer assembly of FIG. 14 wherein the drawer assembly may contain a removable media source here illustrated as a laptop computer (15-2). The drawer may have sufficient space to have a further storage area to contain the power adaptor and cables (15-3) and may retain these fully connected for use at all times.

FIG. 16 is a perspective view of the drawer element similar to FIGS. 14 & 15 and wherein the drawer assembly (16-1) may contain a multiplicity of accessories or media sources in an integral or removable manner and whereby the media does not necessarily require to be removed to be operational. The view illustrates by way of example a DVD player (16-2) and its removable remote controller (16-3) and a sound system and its controls (16-4).

FIG. 17 is a perspective view of a drawer element similar to FIGS. 14, 15 & 16 and wherein the drawer assembly (17-1) may contain an integral videoconferencing system and may contain in an adjacent storage space (17-2) the microphone (17-3) and camera with fold away stand (17-4).

It should be noted that a multiplicity of the accessory storage assemblies shown in FIGS. 13 through 17 could be arranged to be stacked on top of each other. This could be achieved simply by having the underside of the accessory storage assemblies constructed with similar attachment receiving means comprised within the underside of the accessory storage assembly as discussed above (FIG. 13) and matching plug or connection means.

FIG. 18 is a perspective view that shows an alternative configuration of the adaptor assembly, whereby the adaptor assembly (18-1) consists of an enclosure and a base element (18-2) that may be formed to comprise a handle (18-3). The base and enclosure are connected by joints or hinging means (18-4). The figure shows by way of example how the enclosure may pivot up from the base to adjust the height of the projected image. A wide-angle adaptor lens (18-5) similar to that shown in FIG. 12 may be attached (see arrow) to the adaptor assembly.

The arrangement described with reference to FIG. 18 includes an enclosed visual display device. However, the base element (18-2) for adjusting the height of the projected image can equally be used with the present invention, for example with the embodiments of FIGS. 7 and 8. Similarly, a collapsible projection viewing screen, as described with reference to FIG. 19 can be incorporated within an adaptor according to the invention.

FIG. 19 is a perspective view that shows a similar embodiment to that of FIG. 18 and wherein the adaptor assembly (19-1) comprises a mirror (19-2) to reflect the projected image back over the top of the adaptor assembly in the direction shown by the arrow. This particular configuration presents several advantages in that the projector to screen distance is reduced and the mirror (when closed for transport) may also close to act as an automatic projector lens protection. The light path is also raised above any typical obstacles on the table and also reducing the need for keystone adjustment (the undesirable effect produced when the normally rectangular image becomes wider at the top causing the image to become distorted into a trapezium).

FIG. 19 also illustrates a further means whereby the base (19-3) of the adaptor assembly may have attached a further type of accessory storage assembly (19-4). The storage is in the form of an opening enclosure (19-5) to carry accessories such as speakers for a sound system or the signal and/or power cables (not shown). Further, it should be noted that the principles of the accessory storage assembly as illustrated in FIG. 13 through 17 may also be applicable by the attachment of the accessory storage in a similar manner to the base of the adaptor assembly (see example in FIG. 23).

FIG. 20 is a side view similar to the embodiment of FIG. 18 or 19 and wherein the adaptor assembly is in two opening parts attached by hinging means, the upper part (20-1) comprises the projection apparatus (20-9) and is attached by hinging means to its lower part (20-3). This embodiment presents the advantage of improved ventilation of the projection apparatus and if required this could be further improved by moving the projection apparatus out or away from the adaptor assembly by a simple mechanism (but while still remaining attached physically and electrically not shown).

FIG. 20 also shows the mirror element (20-4) in its operational position and may retract to protect the lens in transport (mechanism not shown for clarity) and the path of the reflected projection image (20-5) is directed towards the screen.

FIG. 21 is a side view of an embodiment similar to that of FIGS. 19 & 20 and wherein the adaptor assembly (21-1) and its base (21-2) may have attached above a further accessory storage assembly (21-3) with a lid element (21-4), shown unopened, that may contain other accessories. An example of such an accessory may be a foldable projection screen that attaches to the adaptor assembly by common attachment and hinging points (21-5).

FIG. 22 is a further side view of the embodiment shown in FIG. 21 and wherein the adaptor assembly (22-1) remains attached but is now in an open configuration, a rear projection screen unit. The screen storage assembly (22-2) may pivot upwards and open its lid element (22-3) that comprises a mirror element to reflect the projected image light path (22-4)-shown as dotted lines, onto a screen supported within a frame assembly (22-5). Such a screen may open and close automatically and due to the use of rear projection is suitable for almost all lighting conditions. It also eliminates the dependence on the availability of a screen and as the adjustment of the projection apparatus is eliminated, the unit is operational in several seconds only with no user effort.

FIG. 23 is a perspective view of a preferred embodiment similar to that of FIG. 22 and wherein the adaptor assembly (23-1) is open and inclined with the rear projection assembly (23-2) open and the screen (23-3) ready for use. A videoconferencing accessory storage assembly (23-4) is attached below the base of the adaptor assembly and the accessory storage of FIG. 19 is also attached and contains a sound system. The microphone (23-5) and camera (23-6) are shown removed from the drawer of the videoconferencing accessory storage assembly (drawer shown closed again) and ready for operation. In such a manner a complete and professional videoconferencing system may be carried in a case no large than a typical attache case.

It should be noted that in the previous FIGS. 7 through 23, that the visual display or projection apparatus may be an existing and commercially available projector. It should be further noted that the visual display may further comprise any part, case, enclosure, extension or attachment to the aforesaid commercially available projection apparatus may be constructed to comprise suitable receiving attachment means for the adaptor assembly as described in this application.

It may be further noted that should any part, case, enclosure, extension or attachment to the aforesaid commercially available projector be constructed or configured to act partially or wholly as the adaptor assembly as described with reference to FIGS. 7 through 23, then such an arrangement is considered to be an embodiment of the invention.

Various modifications and improvements may be made within the scope of the appended claims herein intended.

1. An adaptor for attachment to a visual display apparatus having a projection apparatus, the adaptor comprising:
attachment means provided on an exterior of the adaptor, said attachment means adapted to locate and retain a visual display apparatus with the adaptor;
accessory storage means adapted to carry, attach or store accessories as required for visual display or presentation purposes;
signal connection means adapted to enable a visual display apparatus to be connected to an accessory carried or attached in the accessory storage means, thereby enabling the connection of a data, video, or other image signal from the accessory to the visual display apparatus via the adaptor.

2. An adaptor as claimed in claim 1, wherein the signal connection means is an arrangement of electrical contacts.

3. An adaptor as claimed in claim 1, wherein the signal connection means is a wireless connection.

4. (canceled)

5. An adaptor as claimed in claim 1, wherein the accessory storage means is detachable from the adaptor.

6. (canceled)

7. An adaptor as claimed in claim 1, wherein the adaptor comprises a receptacle to receive the accessory storage means.

8. An adaptor as claimed in claim 7 wherein the accessory storage means is at least partially removable from the receptacle.

9. An adaptor as claimed in claim 1, wherein the accessory storage means comprises one or more of the following: a frame around which cables may be stored, an enclosure with an aperture, an enclosure with a door or lid element, an enclosure with compartments.

10. An adaptor as claimed in claim 1, wherein the accessory storage means stores power and/or signal cables, audio-visual media or other image signal sources, communication devices, sound systems, power supplies, remote control devices, computer accessories, or pointing devices.

11. (canceled)

12. (canceled)

13. An adaptor as claimed in claim 1, wherein the accessory storage means is a drawer assembly.

14. An adaptor as claimed in claim 1, wherein the accessory storage means is a removable module.

15. An adaptor as claimed in claim 1, wherein the accessory storage means contains a sub-storage assembly attached to the said accessory storage means.

16. An adaptor as claimed in claim 15, wherein the accessory storage means and the sub-storage assembly each comprise cooperating contact means permitting signal or power interconnection.

17. An adaptor as claimed in claim 1, wherein the adaptor allows the simultaneous attachment of a plurality of accessory storage means in a stackable manner.

18. An adaptor as claimed in claim 1, wherein the accessory storage means contains a collapsible projection-viewing screen.

19. (canceled)

20. An adaptor as claimed in claim 1, wherein the adaptor comprises means for inclining an attached visual display apparatus.

21. An adaptor as claimed in claim 20, wherein the adaptor further comprises an upper assembly adapted to locate and retain a visual display apparatus with the adaptor, and a lower base section, the upper assembly and the lower base section connected by joining means, the joining means permitting the lifting and/or inclination of the visual display apparatus relative to the lower base section.

22. A visual display assembly comprising a visual display device having a projection apparatus and an adaptor, wherein the adaptor has attachment means on its exterior for removable attachment to the visual display device, and the adaptor comprises accessory storage means adapted to carry and/or attach accessories as required for visual display or presentation purposes and signal connection means adapted to connect the visual display device to an accessory carried or attached in the accessory storage means, thereby enabling the connection of a data, video, or other image signal from the accessory to the visual display apparatus via the adaptor.

23. The visual display assembly of claim 22, wherein the adaptor is the adaptor of claim 1.
